(19) United States
(12) Patent Application Publication
(10) Pub. No.: US 2025/0142356 A1
(43) Pub. Date: May 1, 2025

(54) REWARD FOR TILT OPTIMIZATION BASED ON REINFORCEMENT LEARNING (RL)

(71) Applicant: Telefonaktiebolaget LM Ericsson (publ), Stockholm (SE)

(72) Inventors: Jose OUTES CARNERO, Torremolinos (ES); Adriano MENDO MATEO, MÁLAGA (ES); Juan RAMIRO MORENO, MÁLAGA (ES); Yak Ng MOLINA, MÁLAGA (ES); Jose Maria RUIZ AVILES, MÁLAGA (ES); Paulo Antonio MOREIRA MIJARES, MÁLAGA (ES); Rakibul ISLAM RONY, MÁLAGA (ES)

(73) Assignee: Telefonaktiebolaget LM Ericsson (publ), Stockholm (SE)

(21) Appl. No.: 18/722,640

(22) PCT Filed: Feb. 28, 2022
(86) PCT No.: PCT/IB2022/051742

§ 371 Date: Jun. 21, 2024

(30) Foreign Application Priority Data
Jan. 7, 2022 (EP) 22382004.4

(51) Int. Cl. H04W 16/28; H04W 24/08

(52) U.S. Cl. CPC H04W 16/28; H04W 24/08

(57) ABSTRACT

Embodiments include computer-implemented methods for adjusting one or more operational parameters for a first cell of a communication network based on reinforcement learning (RL). Such methods include determining a plurality of reward metric values based on measurements representative of conditions in the first cell and in one or more neighbor cells of the first cell at a corresponding plurality of time instances. Such methods include determining a plurality of reward values based on differences between reward metric values at successive time instances and associating each of the reward values with a corresponding previous action that changed the one or more operational parameters. Such methods include selecting the previous action associated with a highest reward value as an action to change the one or more operational parameters. Other embodiments include RL agents and RL systems configured to perform such methods.

### TECHNICAL FIELD

The present application relates generally to the field of communication networks, and more specifically to techniques for optimizing one or more cell parameters in respective cells of a communication network, e.g., based on reinforcement learning (RL) agents and/or algorithms.

### INTRODUCTION

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

Cellular (e.g., 5G) systems are very complex. Each cell has its own set of configurable parameters, some of which affect only the performance in that cell but others of which also effect performance in neighboring (or neighbor) cells. One parameter of the latter type is called Remote Electrical Tilt (RET), which defines the vertical tilt (e.g., elevation angle) of the main lobe of the cell's antenna. RET can be modified remotely, i.e., without servicing the cell site. Modifying a cell's RET can improve a cell's downlink (DL) signal-to-interference-plus noise ratio (SINR) but may also worsen SINR of neighbor cells. As such, it can be a complex task to determine optimum RETs for a network that includes many cells of various sizes.

Machine learning (ML) is a type of artificial intelligence (AI) that focuses on the use of data and algorithms to imitate the way that humans learn, gradually improving its accuracy. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

One type of ML algorithm is “reinforcement learning” or “RL” for short. RL algorithms train a machine to make specific decisions. In particular, the machine is exposed to an environment in which it trains itself continually using trial and error. The machine learns from experience and tries to capture the best possible knowledge to make accurate decisions in the future. One example of reinforcement learning is the Markov Decision Process.

The expanding scope of 5G applications and use cases puts numerous demands on networks, such as high availability, ultra-reliability, low latency, and high security. Most conventional solutions for mobile network optimization are based on rules defined by highly skilled domain experts who need to translate that knowledge into the proper automation frameworks. These rules are typically static and universal for all networks. The complexity of 5G makes it very challenging to manually devise rule modifications that benefit a specific network case. On the other hand, an RL agent can be pre-trained with general knowledge and then continue to learn in production, providing an optimal policy for each specific scenario.

RL techniques mirror behavioral psychology. The RL agent accumulates knowledge about the dynamics of the environment—the mobile network—through different interactions that may result in positive or negative outcomes depending on how technically sound they are. To train the system, the RL agent interacts with the environment by repeatedly observing its state and then-based on the knowledge available to the agent at each stage-taking actions that are meant to maximize a long-term reward, that is, the improved situation based on defined criteria. In each iteration, the agent will learn from the outcome of the suggested actions and will become increasingly “wiser”. At the beginning of the process, exploration of the environment will naturally be highly erratic, and then gradually become more focused and precise as the iterations proceed and knowledge about the environment's dynamics is improved.

For example, RL has been used for optimizing RET, discussed above. As a more specific example, publication WO2021/190772 describes a solution where each cell is associated with a corresponding unique instance of an RL agent with a unique policy common to all cells. This has the benefit of accelerating the learning by reducing the number of iterations in which the agents may make erroneous exploratory decisions. For example, whatever lesson is learned by the agent instance of one cell is immediately available in the common policy for the agent instances associated with the other cells. For example, the RL agent instances can use a reward function computed based on some Key Performance Indicators (KPI). The reward function can be based on a global reward that is a function of the performance of the entire network or based on a local reward that is a function of the performance of an individual cell.

### SUMMARY

Although an agent can more easily determine which changes resulted in performance improvements when using local reward functions, such improvements are only to individual cells and do not adequately represent the performance of the entire network, which is represented by global reward functions. Thus, there is a conflict between using local and global reward functions.

Embodiments of the present disclosure address these and other problems, issues, and/or difficulties, thereby facilitating the otherwise-advantageous use of RL agents for optimizing cell parameters (e.g., RET) for 5G networks.

Some embodiments include exemplary methods (e.g., procedures) for adjusting one or more operational parameters for a first cell of a communication network based on RL. For example, these exemplary methods can be performed by an RL agent associated with the first cell.

These exemplary methods can include determining a plurality of reward metric values based on measurements representative of conditions in the first cell and in one or more neighbor cells of the first cell at a corresponding plurality of time instances. These exemplary methods can also include determining a plurality of reward values based on differences between reward metric values at successive time instances. These exemplary methods can also include associating each of the reward values with a corresponding previous action that changed the one or more operational parameters. These exemplary methods can also include selecting the previous action associated with a highest reward value as an action to change the one or more operational parameters for the first cell.

In some embodiments, the measurements can be representative of conditions such as DL coverage, DL quality, and congestion. In some embodiments, the one or more operational parameters can include RET of one or more antennas associated with the first cell.

In some embodiments, associating each of the reward values with a corresponding previous action can include the following operations for each of the previous actions:
determining a pre-action state of the one or more operational parameters and a post-action state of the one or more operational parameters;
determining a loss function based on the corresponding reward value and an estimated reward value for performing the previous action on the pre-action state to obtain the post-action state, and
minimizing the loss function to associate the previous action with the reward value.
   In some of these embodiments, the loss function is based on a mean square residual between the reward value and the estimated reward value.

In some embodiments, selecting the previous action can include the following operations:
determining a current state of the one or more operational parameters;
determining respective estimated reward values for performing the previous actions on the current state; and
selecting the previous action associated with the highest estimated reward value as the action to change the current state.

In some of these embodiments, a random one of the previous actions is selected with probability 0≤ε≤1, and the previous action associated with the highest estimated reward value is selected with probability 1-8.

In some embodiments, the reward metric value at time instance t (RMₜ) is determined according to a specific equation given herein, using the following parameters:
GTₜ is the good traffic rate in the first cell at time instance t;
CRₜ is the congestion rate in the first cell at time instance t;
GTNₜ is an average of the good traffic rates in the neighbor cells at time instance t; and
CRNₜ is an average of the congestion rates in the neighbor cells at time instance t.

In some of these embodiments, GTNₜ and CRNₜ are weighted averages, with each neighbor cell's good traffic rate and congestion rate being weighted by a degree of overlap between the first cell and the neighbor cell. In some variants, the respective degrees of overlap between the first cell and the neighbor cells are based on the portion of the total DL traffic in the first cell for which UEs also receive DL reference signals (RS) from the respective neighbor cells.

In some of these embodiments, the good traffic rate at time instance t, for each particular cell of the first cell and one or more neighbor cells, is the portion of total DL traffic in the particular cell that is delivered with good coverage and good quality during a period including or immediately preceding time instance t. In some variants, determining the reward metric at time instance t includes the following operations:
obtaining UE measurements of DL reference signal received power (RSRP) and DL signal-to-interface-plus-noise ratio (SINR) for the particular cell during the period; and
determining the good traffic rate for each particular cell as the portion of total DL traffic, during the period, that is associated with DL RSRP measurements above a first threshold and with DL SINR measurements above a second threshold.

In some of these embodiments, the congestion rate at time instance t, for each particular cell of the first cell and one or more neighbor cells, is the congestion rate for RRC signaling in the particular cell during a period including or immediately preceding time instance t.

In some of these embodiments, the reward value at time instance t+1 (Rₜ₊₁) is determined according to a specific equation given herein, based on reward metric values at time instances t and t+1.

Other embodiments include RL agents and multi-agent systems (or network nodes hosting the same) that are configured to perform the operations corresponding to any of the exemplary methods described herein. Other embodiments include non-transitory, computer-readable media storing computer-executable instructions that, when executed by processing circuitry, configure such RL agents and systems to perform operations corresponding to any of the exemplary methods described herein.

Reward functions determined according to these and other disclosed embodiments can provide improved and/or optimal capture of impacts of cell parameter (e.g., RET) changes to the cell being modified as well as to its neighbor cells. When used in RL-based RET optimization, such embodiments can increase DL user throughout in the cells of a network for the same traffic volume, particularly when compared to conventional reward functions based on either global or local rewards. At a high level, RL-based RET optimization using the novel reward function improves cellular network performance (e.g., capacity, throughput, etc.).

These and other objects, features, and advantages of the present disclosure will become apparent upon reading the following Detailed Description in view of the Drawings briefly described below.

### BRIEF DESCRIPTION OF THE DRAWINGS

FIG. 1 shows an exemplary 5G network architecture.

FIG. 2 illustrates an exemplary reinforcement learning (RL) framework in the context of a Markov Decision Process.

FIG. 3 illustrates an exemplary architecture of a deep neural network (DNN).

FIG. 4 shows an exemplary deployment of multiple instances of an RL agent in a cellular network, according to various embodiments of the present disclosure.

FIG. 5 shows a block diagram of a Q-Learning scheme for RET optimization using one RL agent per cell, according to various embodiments of the present disclosure.

FIG. 6 shows an exemplary method (e.g., procedure) for adjusting one or more operational parameters for a first cell of a communication network based on RL, according to various embodiments of the present disclosure.

FIG. 7 shows a communication system according to various embodiments of the present disclosure.

FIG. 8 shows a UE according to various embodiments of the present disclosure.

FIG. 9 shows a network node according to various embodiments of the present disclosure.

FIG. 10 shows host computing system according to various embodiments of the present disclosure.

FIG. 11 is a block diagram of a virtualization environment in which functions implemented by some embodiments of the present disclosure may be virtualized.

FIG. 12 illustrates communication between a host computing system, a network node, and a UE via multiple connections, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms may be used in the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of functionalities such as session management, connection management, charging, authentication, etc.

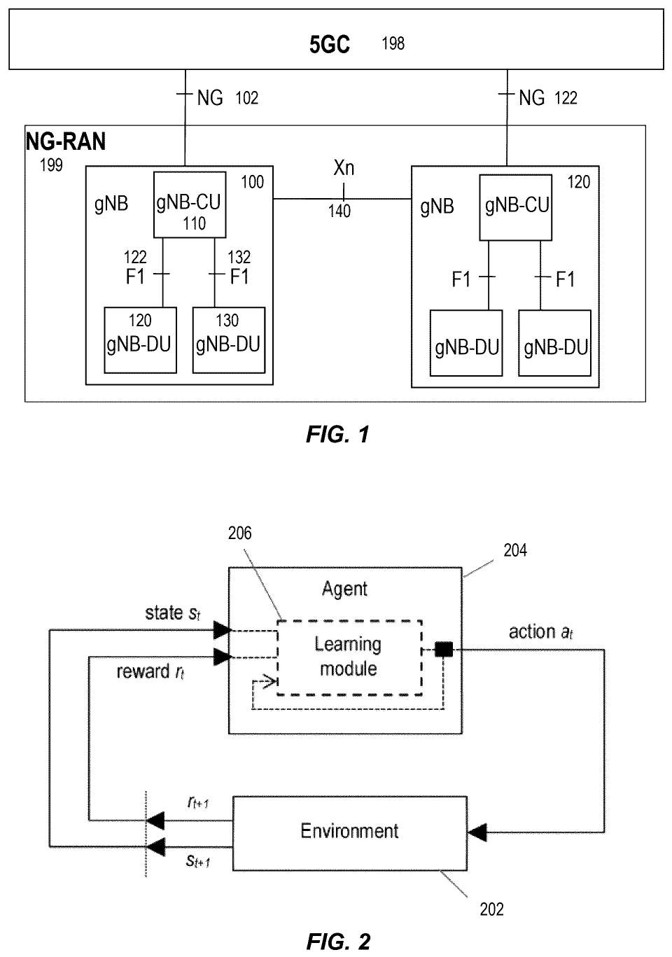

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region” with the term “AMF” referring to an access and mobility management function in the 5GC.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

As briefly mentioned above, RL algorithms train a machine (e.g., computer) to make specific decisions. In particular, the machine is exposed to an environment in which it trains itself using trial and error. The machine learns from experience and tries to capture knowledge to make accurate decisions in the future.

FIG. 2 illustrates an exemplary RL framework in the context of a Markov Decision Process. The framework shown in FIG. 2 includes an environment 202 (e.g., a cell or a network of cells, an RL agent 204 having a learning module 206, a set of environment and agent states(S), a set of agent actions (A), and a reward (r). The probability of a transition from state s at time t to state s′ at time t+1 under action a at time t is given by:

$$P ( s , a , {s}^{′} ) = Pr ( st + 1 = {s}^{′} \vert st = s , at = a ) \qquad ( 1 )$$

and an immediate reward after a transition from s to s′ under action a is given by:

$$r ( s , a , {s}^{′} ) . \qquad ( 2 )$$

RL agent 204 interacts with its environment 202 in discrete time instances. At each time instance (e.g., t), the agent 204 receives an observation Ot, which typically includes the reward rₜ. RL agent 204 then selects an action a from the set of available actions A and applies the selection action to the environment. The environment moves to a new state sₜ₊₁ and the reward rₜ₊₁ associated with the transition (sₜ, aₜ, sₜ₊₁) is determined. The goal of the RL agent 204 is to collect as much reward as possible.

The selection of the action by the agent is modelled by a “policy map” given by:

$$π : A \times S \to [ 0 , 1 ] \qquad ( 3 )$$

$$π ( a , s ) = Pr ( {a}_{t} = a \vert {s}_{t} = s ) \qquad ( 4 )$$

The policy map gives the probability of taking action a when in state s. Given state s, action a, and policy π, the action-value of the pair (s, a) under policy π is defined by:

$${Q}^{π} ( s , a ) = E [ R \vert s , a , π ] \qquad ( 5 )$$

where the random variable R denotes the return, and is defined as the sum of future discounted rewards:

$$R = \text{?} {γ}^{t} {r}_{t} \qquad ( 6 )$$

$$\text{?} \text{indicates text missing or illegible when filed}$$

where rₜ is the reward at instance t and 0≤γ≤1 is the discount rate.

The theory of Markov Decision Processes states that if π* is an optimal policy, taking the optimal action is carried out by choosing the action from Q^{π}* with the highest value at each state s. The action-value function of such optimal policy (Q^{π}*) is also called the optimal action-value function and is commonly denoted Q*. In summary, the optimal action-value function Q* provides suffices knowledge for how to act optimally.

Assuming full knowledge of the Markov Decision Process, the two basic approaches to compute the optimal action-value function are value iteration and policy iteration. Both algorithms compute a sequence of functions Qₖ (k=0, 1, 2, etc.) that converge to Q*. Computing these functions involves computing expectations over the state-space, which is impractical for all but the smallest (finite) Markov Decision Processes. In RL methods, expectations are approximated by averaging over samples and using function approximation techniques to represent value functions over large state-action spaces. One of the most commonly used RL methods is Q-Learning.

Training the RL agent 204 involves learning the Q(s, a) function for all possible states and actions. The actions are typically three in this case (i.e., maintain, increase, decrease), but the state is composed of N continuous features, giving an infinite number of possible states. A tabular function for Q may not be the most appropriate approach for this agent. Although a continuous/discrete converter might be included as a first layer, the usage of a deep neural network is more suitable, because it handles continuous features directly.

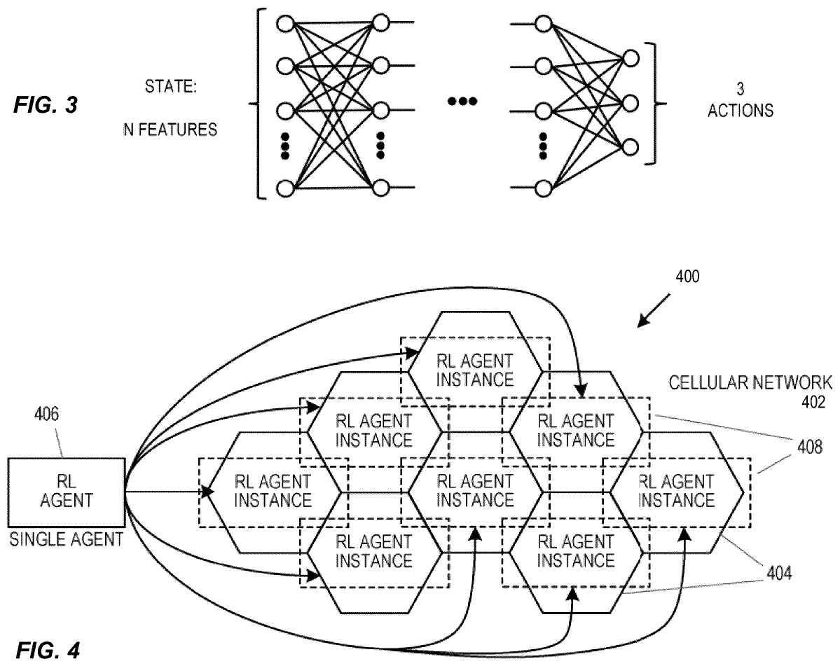

FIG. 3 illustrates an exemplary architecture of a deep neural network (DNN). Given a state s represented by N continuous features, the output of the neural network is the Q value for the three possible actions. The problem, when expressed in this way, is reduced to a regression problem. One method to solve this regression problem is called Q-Learning, which consists of generating tuples (state, action, reward, next state)=(s, a, r, s′) and solve the following supervised learning problem iteratively:

$$Q = ( s , a ) = r + γ \text{?} Q ( {s}^{′} , {a}^{′} ) \qquad ( 7 )$$

$$\text{?} \text{indicates text missing or illegible when filed}$$

Actions to generate the tuples can be selected in any way, but a common method is called ‘epsilon-greedy policy”, in which a hyper-parameter (ε) in the range [0, 1] controls the balance between exploration (where the action is selected randomly) and exploitation (the best action is selected, i.e., argmax Q(s, a)). Q-Learning is a well-known RL algorithm, but other methods such as State-Action-Reward-State-Action (SARSA), Expected Value SARSA (EV-SARSA), Reinforce Baseline, and Actor-critic can also be used.

As briefly mentioned above, RL has been used for optimizing Remote Electrical Tilt (RET), which defines the vertical tilt (e.g., elevation angle) of the main lobe of the cell's antenna. FIG. 4 shows an exemplary deployment of multiple instances of an RL agent in a cellular network. The cellular network 402 includes a plurality of cells 404, which for ease of illustration are shown as non-overlapping hexagonal cells. Each cell will be managed and provided by a base station (e.g., eNB, gNB, etc.), with each base station providing one or more cells 404. A single RL agent 406 is implemented with a policy to determine if and how a cell parameter (such as RET) needs to be modified or adjusted. Each of the cells 404 is associated with a corresponding instance 408 of RL agent 406. Information (e.g., measurements) related to the cell parameter changes in the respective cells 404 is collected during cell operation, and this information is used to update the policy.

Although one independent instance of the RL agent 406 is deployed per cell 404, the policy of each agent 406 is the same and can be updated accordingly with the feedback (measurements, etc.) coming from all the RL agent instances 408. The arrangement shown in FIG. 4 can be considered a single distributed agent, which makes training phase easier because only a single unique policy must be trained. An alternative way to view the deployment in FIG. 4 is that each RL agent instance 408 is a respective RL agent 406 that has the same policy as the other RL agents 406, with each agent's copy of the policy being updated as the policy is trained.

Since an action taken by an agent instance 408 in a cell 404 (e.g., increasing or decreasing the value of a cell parameter) affects not only that cell but also neighbor cells, it is necessary to have visibility into all surrounding cells. Therefore, although RL agent 406 is shown in FIG. 4 as logically distributed in all the cells 404, all the agent instances 408 could be implemented in a centralized point where all the cells 404 report their status. The centralized point can be in the core network (CN, e.g., 5GC) of the cellular network 402, or even outside of the cellular network 402.

Each RL agent 406/408 steers the cell parameters towards the optimal global solution by suggesting small incremental changes, while the single (shared) policy is updated accordingly with the feedback received from all the instances 408 of the RL agent 406. The status of the cells 404 is typically defined by continuous variables (e.g., parameters, KPls, etc.) so tabular RL algorithms cannot be used directly. Rather, deep neural networks can be used by the RL agent 406 since they can inherently manage continuous variables.

An RL agent 406 with a suitably trained policy can outperform expert-defined agents in terms of long-term performance. To avoid the initial policy training phase with corresponding network degradation, an offline agent initialization phase can be performed before putting the policy and RL agent 406 in place in the actual network. One approach is to deploy an agent 406 that is similar to an expert-trained agent in terms of performance and, after that, allow it to be trained to further improve the performance in the actual deployment. This can be done, for example, using a network simulator, network data, and an expert system. This transfer learning process is quite straightforward—the same trained agent 406 can be used when new cells 404 are integrated into the network 402 or in the case of completely new network installations, the offline initialized agent can be used instead.

As discussed above in relation to FIG. 2, RL agents operate based on rewards. For example, existing solutions based on one RL agent per cell—such as shown in FIG. 4—typically are based on a global reward or a local reward. Global rewards are functions of the performance of the whole network. In such case, the contribution of a parameter change in a particular cell to the global reward might be very small and may be masked by parameter changes in other cells of the network. As such, it may be very difficult for the RL agent to determine which changes improved and which changes degraded.

In contrast, local rewards are functions of the performance of a single cell associated with RL agent (e.g., agent instances as in FIG. 4). In this case, there is a different reward value associated with a parameter change at each cell. As such, it is much easier for an RL agent to determine whether a parameter change caused an improvement or a degradation for a particular cell—although the RL agent has no information about the impact of the parameter change on other cells of the network.

Accordingly, embodiments of the present disclosure address these and other problems, issues, and/or difficulties by providing techniques to define and utilize a RL reward scheme, such as used to optimize the RET of the cells in a wireless network. The reward function can be used in an RL scheme that involves multiple instances (one per cell) of the same RL agent. The novel reward function disclosed herein can capture the relative performance improvement in a particular cell being modified as well as the resulting performance change in neighboring cells (e.g., with respect to the performance before the change is applied).

Embodiments can determine performance based on the sum of the good traffic rate and the accessibility rate of the cell being modified (e.g., optimized cell), plus the average good traffic and the average accessibility rate at some N closest neighbor cells, weighted by respective factors corresponding to overlap between the respective neighbor cells and the cell being modified. As an example, the accessibility rate of a cell can be calculated as one minus the Radio Resource Control (RRC) congestion rate in the cell, as discussed in greater detail below. Embodiments can determine performance based on the sum of the good traffic rate and the accessibility rate of the cell being modified (e.g., optimized cell), plus the average good traffic and the average accessibility rate at some N closest neighbor cells, weighted by respective factors corresponding to overlap between the respective neighbor cells and the cell being modified. As an example, the accessibility rate of a cell can be calculated as one minus the Radio Resource Control (RRC) congestion rate in the cell, as discussed in greater detail below.

These techniques provide various benefits and/or advantages. For example, a reward function determined according to these techniques provides an improved and/or optimal capture of the impact of cell parameter (e.g., RET) changes to be the cell being modified and its neighbor cells. When used in RL models for RET optimization, such embodiments can increase DL user throughput in the cells of a network for the same traffic volume, particularly when compared to conventional reward functions based on either global or local rewards.

As mentioned above, when optimizing RET using one RL agent (or instance) per cell (e.g., as shown in FIG. 4), it is necessary and/or desirable to consider the impact of an RET change on neighbor cells of the cell being modified. To achieve this, the RL agent in each cell must also have visibility into the neighbor cells, and this condition must be reflected in the definitions of the state and the reward for the ML model.

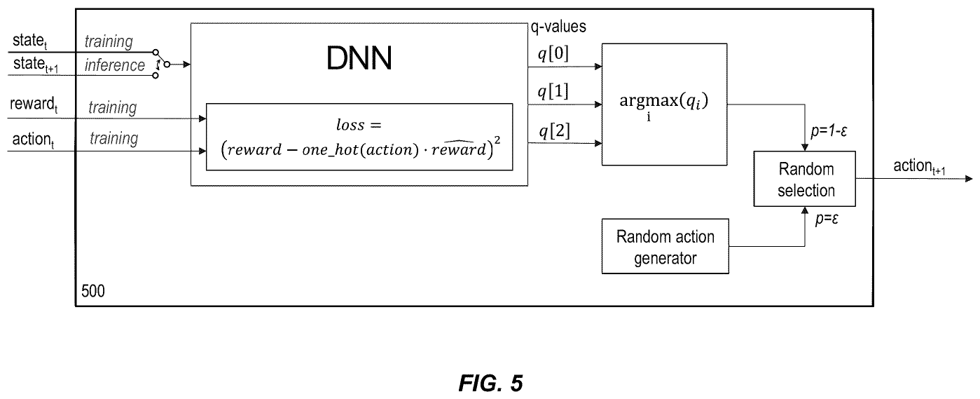

FIG. 5 shows a block diagram of a Q-Learning scheme for RET optimization using one RL agent per cell, according to various embodiments of the present disclosure. The reward function used in FIG. 5 captures the relative improvement/degradation of performance in the cell being modified as well as in some neighbor cells. For example, the reward at time instance t+1 can be defined as:

$${R}_{t + 1} = 1000 \cdot \frac{{RM}_{t + 1} - {RM}_{t}}{{RM}_{t}} , \qquad ( 8 )$$

where RMₜ₊₁ is the reward metric (RM) at instant t+1 (after the parameter update) and RMₜ is the reward metric at instant t (before the parameter update). The reward metric at instant t is computed as:

$${RM}_{t} = {GT}_{t} + {GTN}_{t} + ( 1 - {CR}_{t} ) + ( 1 - {CRN}_{t} ) , \qquad ( 9 )$$

where GTₜ and CRₜ are the good traffic rate and the congestion rate at the cell at instant t respectively, and GTNₜ and CRNₜ are the average good traffic and the average congestion rate measured at instant t at the closest neighboring cells, weighted by their overlapping factors with respect to the studied cell.

“Good traffic rate” is defined as the ratio of traffic with good coverage and good quality relative to total traffic. “Good coverage” means having DL reference signal received power (RSRP) greater than a predefined threshold, while “good quality” means having DL SINR (or reference signal received quality, RSRQ) greater than a predefined threshold. The overlapping factor of a second cell to a first cell can be calculated as follows:

first cell DL traffic with which UEs also detect second cell DL RS/total first cell DL traffic

For example, the overlapping factor can be computed as the periodicity in which both cells are reported simultaneously by a single UE in cell traffic recording (CTR). Congestion rate can be, or be based on, the RRC congestion rate.

Note that a Deep Neural Network (DNN) is used to predict the reward in the arrangement shown in FIG. 5, and a discount rate of γ=0 is used. At every instant t+1, the optimizer carries out these two tasks:
1. Training: based on the previous state of the network (stateₜ), the previous implemented action (actionₜ) and the obtained reward (rewardₜ) resulting from applying actionₜ. The DNN is trained by minimizing a loss function defined as the mean square residuals between the estimated and the measured rewards. A one hot encoded vector can be used to represent the action from which every reward is obtained. By using the inner product of the one hot encoded vector and the estimated reward, the DNN can associate every reward input with the corresponding action used to obtain it.
2. Inference: the action with highest expected reward (max q-value) is determined as the next actionₜ₊₁. The expected rewards q[i] for every possible action are obtained by using the current state (stateₜ₊₁) and every possible action[i] as inputs to the DNN. In this case, an epsilon-greedy policy is used to select an exploratory random action with probability ε; otherwise, the action with the highest q-value (expected reward) is selected.

In the arrangement shown in FIG. 5, the reward can be forced to zero when the action implies no RET changes. This is possible due to the reward definition as a metric of relative performance difference before and after applying the action. Forcing a reward to zero when there are no RET changes accelerates the learning phase.

In some variants, the closest neighbor cells can be weighted by different KPIs other than or in addition to GTNₜ and (1−CRNₜ) used in (9). For example, the closest neighbor cells can be weighted based on as cell traffic. In some variants, an extra weight (e.g., multiplicative or additive factor) can be applied to the KPIs associated with the neighbor cells (i.e., GTNₜ and (1−CRNₜ)) to modulate the relative importance of the neighbor cells with respect to the cell for which the reward is calculated.

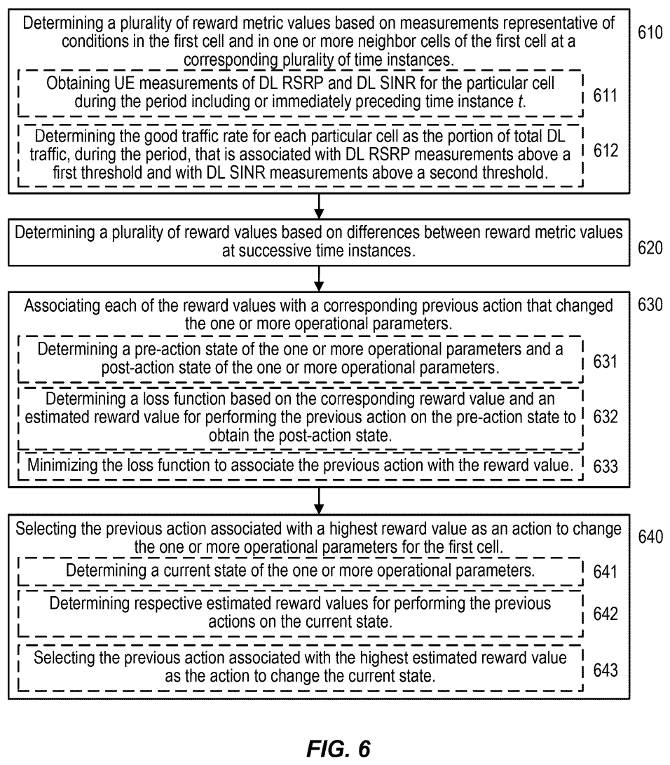

The embodiments described above can be further illustrated with reference to FIG. 6, which depicts an exemplary method (e.g., procedures) for adjusting one or more operational parameters for a first cell of a communication network based on reinforcement learning (RL), according to various embodiments of the present disclosure. In other words, various features of the operations described below correspond to various embodiments described above. Although the exemplary method is illustrated in FIG. 6 by specific blocks in a particular order, the operations corresponding to the blocks can be performed in a different order than shown and can be combined and/or divided into blocks and/or operations having different functionality than shown. Optional blocks and/or operations are indicated by dashed lines.

The exemplary method shown in FIG. 6 can be performed by an RL agent associated with the first cell, such as described elsewhere herein. The exemplary method can include the operations of block 610, where the RL agent can determine a plurality of reward metric values based on measurements representative of conditions in the first cell and in one or more neighbor cells of the first cell at a corresponding plurality of time instances. The exemplary method can also include the operations of block 620, where the RL agent can determine a plurality of reward values based on differences between reward metric values at successive time instances. The exemplary method can also include the operations of block 630, where the RL agent can associate each of the reward values with a corresponding previous action that changed the one or more operational parameters. The exemplary method can also include the operations of block 640, where the RL agent can select the previous action associated with a highest reward value as an action to change the one or more operational parameters for the first cell.

In some embodiments, the measurements can be representative of conditions such as DL coverage, DL quality, and congestion. In some embodiments, the one or more operational parameters can include remote electrical tilt (RET) of one or more antennas associated with the first cell.

In some embodiments, associating each of the reward values with a corresponding previous action (e.g., in block 630) includes the following operations (with corresponding sub-block numbers) for each of the previous actions:
(631) determining a pre-action state of the one or more operational parameters and a post-action state of the one or more operational parameters;
(632) determining a loss function based on the corresponding reward value and an estimated reward value for performing the previous action on the pre-action state to obtain the post-action state, and
(633) minimizing the loss function to associate the previous action with the reward value.

In some of these embodiments, the loss function is based on a mean square residual between the reward value and the estimated reward value, such as discussed above in relation to FIG. 5.

In some embodiments, selecting the previous action (e.g., in block 640) includes the following operations (with corresponding sub-block numbers):
(641) determining a current state of the one or more operational parameters;
(642) determining respective estimated reward values for performing the previous actions on the current state; and
(643) selecting the previous action associated with the highest estimated reward value as the action to change the current state.

In some of these embodiments, a random one of the previous actions is selected with probability 0≤ε≤1, and the previous action associated with the highest estimated reward value is selected with probability 1-8.

In some embodiments, the reward metric value at time instance t (RMₜ) is determined (e.g., in block 610) according to equation (9) above, using the following parameters:
GTₜ is the good traffic rate in the first cell at time instance t;
CRₜ is the congestion rate in the first cell at time instance t;
GTNₜ is an average of the good traffic rates in the neighbor cells at time instance t; and
CRNₜ is an average of the congestion rates in the neighbor cells at time instance t.

In some of these embodiments, GTNₜ and CRNₜ are weighted averages, with each neighbor cell's good traffic rate and congestion rate being weighted by a degree of overlap between the first cell and the neighbor cell. In some variants, the respective degrees of overlap between the first cell and the neighbor cells are based on the portion of the total DL traffic in the first cell for which UEs also receive DL reference signals (RS) from the respective neighbor cells.

In some of these embodiments, the good traffic rate at time instance t, for each particular cell of the first cell and one or more neighbor cells, is the portion of total DL traffic in the particular cell that is delivered with good coverage and good quality during a period including or immediately preceding time instance t. In some variants, determining the reward metric at time instance t (e.g., in block 610) includes the following operations (with corresponding sub-block numbers):
(611) obtaining UE measurements of DL reference signal received power (RSRP) and DL signal-to-interface-plus-noise ratio (SINR) for the particular cell during the period; and
(612) determining the good traffic rate for each particular cell as the portion of total DL traffic, during the period, that is associated with DL RSRP measurements above a first threshold and with DL SINR measurements above a second threshold.

In some of these embodiments, the congestion rate at time instance t, for each particular cell of the first cell and one or more neighbor cells, is the congestion rate for RRC signaling in the particular cell during a period including or immediately preceding time instance t.

In some of these embodiments, the reward value at time instance t+1 (Rₜ₊₁) is determined according to equation (8) above, where RMₜ and RMₜ₊₁ are reward metric values at time instances t and t+1, respectively.

Although the above description of FIG. 6 is from the perspective of an individual RL agent associated with a particular cell, such operations can also be performed by an RL system comprising a plurality of RL agents associated with the respective plurality of cells of the communication network. In such case, each RL agent can perform the operations described above with reference to FIG. 6, i.e., with respect to its associated cell.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

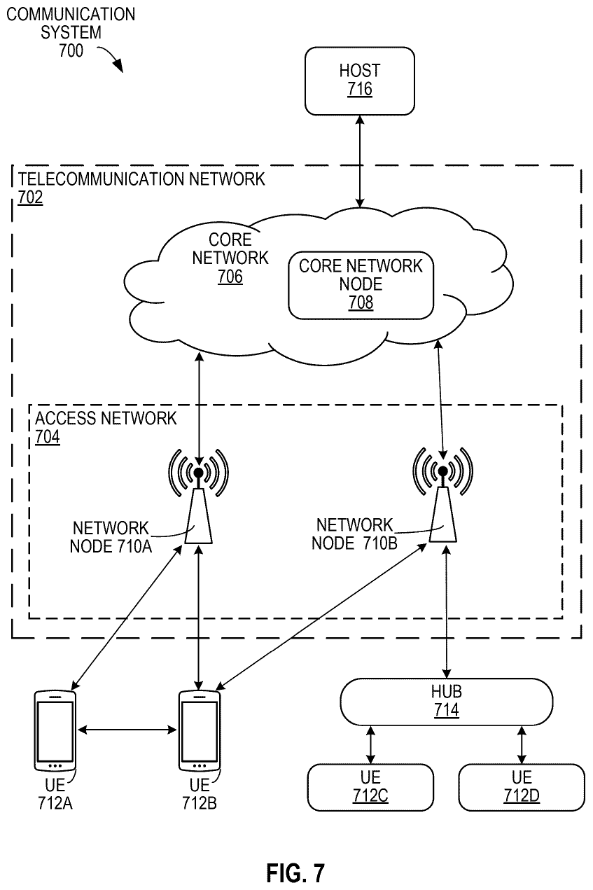

FIG. 7 shows an example of a communication system 700 in accordance with some embodiments. In this example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one or more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

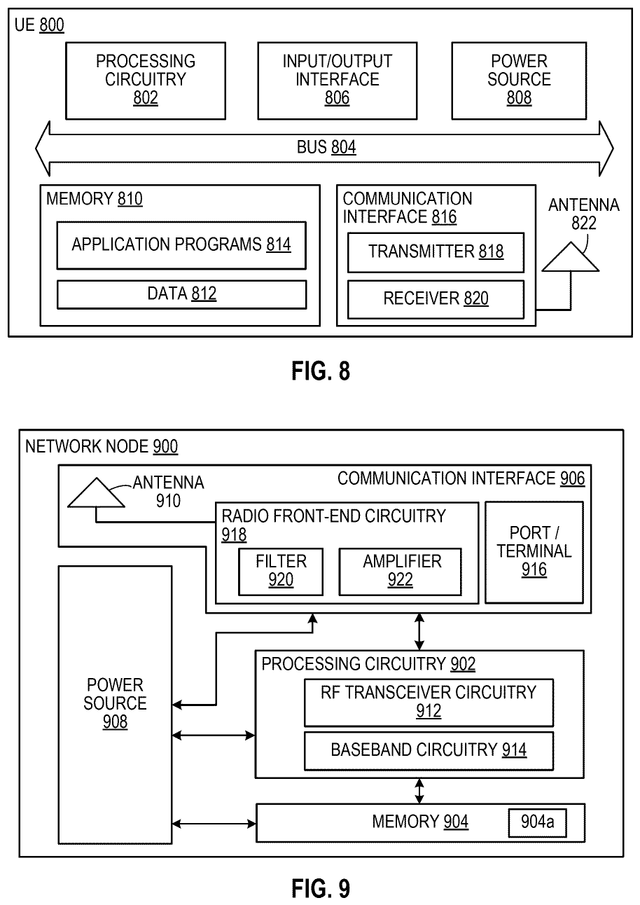

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

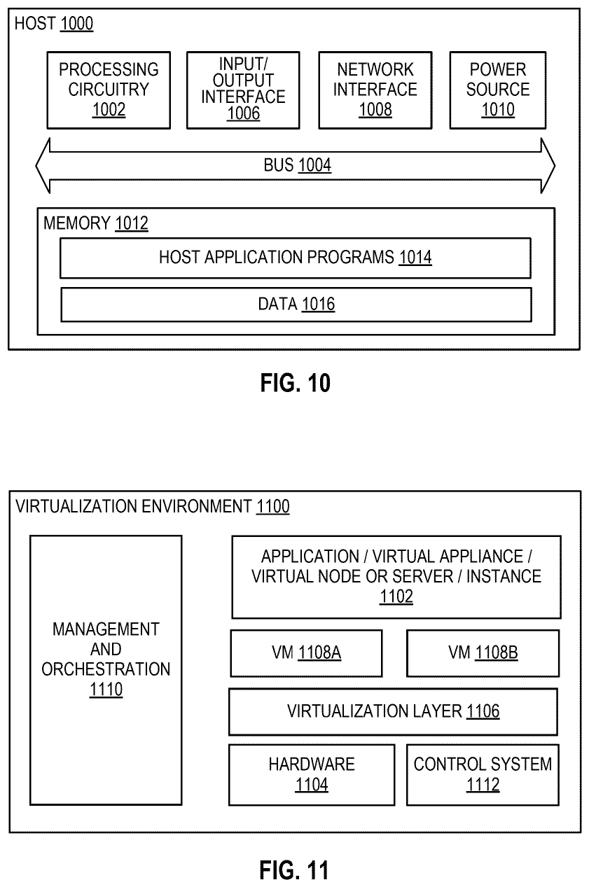

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

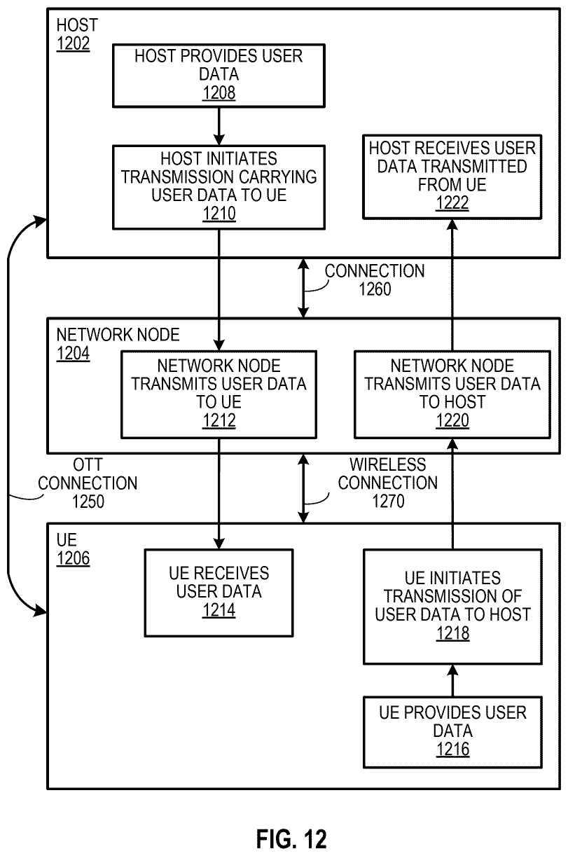

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. Embodiments include RL-based network optimization using reward functions that provide improved and/or optimal capture of the impact of cell parameter (e.g., RET) changes to the cell being modified as well as to its neighbor cells. When used in RL-based RET optimization, such embodiments can increase DL user throughout in the cells of a network for the same traffic volume, particularly when compared to conventional reward functions based on either global or local rewards. Such improved network performance can increase the value of OTT services delivered via the network to both service providers and end users.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above or by supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein include, but are not limited to, the following enumerated examples:
A1. A computer-implemented method for adjusting one or more operational parameters for a first cell of a communication network based on reinforcement learning (RL), the method comprising:
   determining a plurality of reward metric values based on measurements representative of conditions in the first cell and in one or more neighbor cells of the first cell at a corresponding plurality of time instances;
   determining a plurality of reward values based on differences between reward metric values at successive time instances;
   associating each of the reward values with a corresponding previous action that changed the one or more operational parameters; and
   selecting the previous action associated with a highest reward value as an action to change the one or more operational parameters for the first cell.
A2. The method of embodiment A1, wherein the method is performed by an RL agent associated with the first cell.
A3. The method of any of embodiments A1-A2, wherein the conditions include downlink (DL) coverage, DL quality, and congestion.
A4. The method of any of embodiments A1-A3, wherein associating each of the reward values with a corresponding previous action comprises, for each of the previous actions:
   determining a pre-action state of the one or more operational parameters and a post-action state of the one or more operational parameters;
   determining a loss function based on the corresponding reward value and an estimated reward value for performing the previous action on the pre-action state to obtain the post-action state, and
   minimizing the loss function to associate the previous action with the reward value.
A5. The method of embodiment A4, wherein the loss function is based on a mean square residual between the reward value and the estimated reward value.
A6. The method of any of embodiments A1-A5, wherein selecting the previous action comprises:
   determining a current state of the one or more operational parameters;
   determining respective estimated reward values for performing the previous actions on the current state; and
   selecting the previous action associated with the highest estimated reward value as the action to change the current state.
A7. The method of embodiment A6, wherein:
   a random one of the previous actions is selected with probability 0≤8≤1; and
   the previous action associated with the highest estimated reward value is selected with probability 1-ε.
A8. The method of any of embodiments A1-A7, wherein the reward metric value at time instance t (RMₜ) is determined according to:

$${RM}_{t} = {GT}_{t} + {GTN}_{t} + ( 1 - {CR}_{t} ) + ( 1 - {CRN}_{t} )$$

and wherein:
   GTₜ is the good traffic rate in the first cell at time instance t;
   CRₜ is the congestion rate in the first cell at time instance t;
   GTNₜ is an average of the good traffic rates in the neighbor cells at time instance t; and
   CRNₜ is an average of the congestion rates in the neighbor cells at time instance t.
A9. The method of embodiment A8, wherein GTNₜ and CRNₜ are weighted averages, with each neighbor cell's good traffic rate and congestion rate being weighted by a degree of overlap between the first cell and the neighbor cell.
A10. The method of embodiment A9, wherein the respective degrees of overlap between the first cell and the neighbor cells are based on the portion of the total DL traffic in the first cell for which UEs also receive DL reference signals (RS) from the respective neighbor cells.
A11. The method of any of embodiments A8-A10, wherein the good traffic rate at time instance t, for each particular cell of the first cell and one or more neighbor cells, is the portion of total downlink (DL) traffic in the particular cell that is delivered with good coverage and good quality during a period including or immediately preceding time instance t.
A12. The method of embodiment A11, wherein determining the reward metric at time instance t comprises:
   obtaining user equipment (UE) measurements of downlink (DL) reference signal received power (RSRP) and DL signal-to-interface-plus-noise ratio (SINR) for the particular cell during the period; and
   determining the good traffic rate for each particular cell as the portion of total DL traffic, during the period, that is associated with DL RSRP measurements above a first threshold and with DL SINR measurements above a second threshold.
A13. The method of any of embodiments A8-A12, wherein the congestion rate at time instance t, for each particular cell of the first cell and one or more neighbor cells, is the congestion rate for radio resource control (RRC) signaling in the particular cell during a period including or immediately preceding time instance t.
A14. The method of any of claims A8-A13, wherein the reward value at time instance t+1 (Rₜ₊₁) is determined according to:

$${R}_{t + 1} = 1000 \cdot \frac{{RM}_{t + 1} - {RM}_{t}}{{RM}_{t}}$$

where RMₜ and RMₜ₊₁ are reward metric values at time instances t and t+1, respectively.
A15. The method of any of embodiment A1-A13, wherein the one or more operational parameters include remote electrical tilt (RET) of one or more antennas associated with the first cell.
A16. A computer-implemented method for adjusting one or more operational parameters for a plurality of cells of a communication network, the method being performed by a reinforcement learning (RL) system comprising a plurality of RL agents associated with the respective plurality of cells, with each RL agent performing operations corresponding to any of the methods of embodiments A1-A15.
B1. A reinforcement learning (RL) agent configured to adjust one or more operational parameters for a first cell of a communication network, wherein:
   the RL agent is implemented by communication interface circuitry and processing circuitry that are operably coupled and configured to communicate with at least a network node that provides the first cell; and
   the processing circuitry and interface circuitry are configured to perform operations corresponding to any of the methods of embodiments A1-A15.
B2. A reinforcement learning (RL) agent configured to adjust one or more operational parameters for a first cell of a communication network, wherein the RL agent is configured to perform operations corresponding to any of the methods of embodiments A1-A15.
B3. A reinforcement learning (RL) system configured to adjust one or more operational parameters for a plurality of cells of a communication network, wherein the RL system includes a plurality of the RL agents of embodiment B1 or B2, with each RL agent being associated with a different one of the cells.
B4. A non-transitory, computer-readable medium storing computer-executable instructions that, when executed by processing circuitry associated with a reinforcement learning (RL) agent configured to adjust one or more operational parameters for a first cell of a communication network, configure the RL agent to perform operations corresponding to any of the methods of embodiments A1-A15.
B5. A non-transitory, computer-readable medium storing computer-executable instructions that, when executed by processing circuitry associated with a reinforcement learning (RL) system configured to adjust one or more operational parameters for a plurality of cells of a communication network, configure the RL system to perform operations corresponding to the method of embodiment A16.
B6. A computer program product comprising computer-executable instructions that, when executed by processing circuitry associated with a reinforcement learning (RL) agent configured to adjust one or more operational parameters for a first cell of a communication network, configure the RL agent to perform operations corresponding to any of the methods of embodiments A1-A15.
B7. A computer program product comprising computer-executable instructions that, when executed by processing circuitry associated with a reinforcement learning (RL) system configured to adjust one or more operational parameters for a plurality of cells of a communication network, configure the RL system to perform operations corresponding to the method of embodiment A16.

1. A computer-implemented method for adjusting one or more operational parameters for a first cell of a communication network based on reinforcement learning, RL, the method comprising:
determining a plurality of reward metric values based on measurements representative of conditions in the first cell and in one or more neighbor cells of the first cell at a corresponding plurality of time instances;
determining a plurality of reward values based on differences between reward metric values at successive time instances;
associating each of the reward values with a corresponding previous action that changed the one or more operational parameters; and
selecting the previous action associated with a highest reward value as an action to change the one or more operational parameters for the first cell.

2. The method of claim 1, wherein the method is performed by an RL agent associated with the first cell.

3. The method of claim 1, wherein the conditions include the following: downlink, DL, coverage; DL quality; and congestion.

4. The method of claim 1, wherein associating each of the reward values with a corresponding previous action comprises, for each of the previous actions:
determining a pre-action state of the one or more operational parameters and a post-action state of the one or more operational parameters;
determining a loss function based on the corresponding reward value and an estimated reward value for performing the previous action on the pre-action state to obtain the post-action state, and
minimizing the loss function to associate the previous action with the reward value.

5. The method of claim 4, wherein the loss function is based on a mean square residual between the reward value and the estimated reward value.

6. The method of claim 1, wherein selecting the previous action comprises:
determining a current state of the one or more operational parameters;
determining respective estimated reward values for performing the previous actions on the current state; and
selecting the previous action associated with the highest estimated reward value as the action to change the current state.

7. The method of claim 6, wherein:
a random one of the previous actions is selected with probability 0≤ε≤1; and
the previous action associated with the highest estimated reward value is selected with probability 1-ε.

8. The method of claim 1, wherein the reward metric value at time instance t, RMₜ, is determined according to:
$${RM}_{t} = {GT}_{t} + {GTN}_{t} + ( 1 - {CR}_{t} ) + ( 1 - {CRN}_{t} )$$
and wherein:
GTₜ is the good traffic rate in the first cell at time instance t;
CRₜ is the congestion rate in the first cell at time instance t;
GTNₜ is an average of the good traffic rates in the neighbor cells at time instance t; and
CRNₜ is an average of the congestion rates in the neighbor cells at time instance t.

9. The method of claim 8, wherein GTNₜ and CRNₜ are weighted averages, with each neighbor cell's good traffic rate and congestion rate being weighted by a degree of overlap between the first cell and the neighbor cell.

10. The method of claim 9, wherein the respective degrees of overlap between the first cell and the neighbor cells are based on the portion of the total DL traffic in the first cell for which UEs also receive DL reference signals, RS, from the respective neighbor cells.

11. The method of claim 8, wherein the good traffic rate at time instance t, for each particular cell of the first cell and one or more neighbor cells, is the portion of total downlink, DL, traffic in the particular cell that is delivered with good coverage and good quality during a period including or immediately preceding time instance t.

12. The method of claim 11, wherein determining the reward metric value at time instance t comprises:
obtaining user equipment, UE, measurements of DL reference signal received power, RSRP, and DL signal-to-interface-plus-noise ratio, SINR, for the particular cell during the period including or immediately preceding time instance t; and
determining the good traffic rate for each particular cell as the portion of total DL traffic, during the period including or immediately preceding time instance t, that is associated with DL RSRP measurements above a first threshold and with DL SINR measurements above a second threshold.

13. The method of claim 8, wherein the congestion rate at time instance t, for each particular cell of the first cell and one or more neighbor cells, is the congestion rate for radio resource control, RRC, signaling in the particular cell during a period including or immediately preceding time instance t.

14. The method of claim 8, wherein the reward value at time instance t+1, Rₜ₊₁, is determined according to:
$${R}_{t + 1} = 1000 \cdot \frac{{RM}_{t + 1} - {RM}_{t}}{{RM}_{t}}$$
where RMₜ and RMₜ₊₁ are reward metric values at time instances t and t+1, respectively.

15. The method of claim 1, wherein the one or more operational parameters include remote electrical tilt, RET, of one or more antennas associated with the first cell.

16. (canceled)

17. A reinforcement learning, RL, agent configured to adjust one or more operational parameters for a first cell of a communication network, wherein:
the RL agent is implemented by communication interface circuitry and processing circuitry that are operably coupled and configured to communicate with at least a network node that provides the first cell; and
the processing circuitry and interface circuitry are configured to:
determine a plurality of reward metric values based on measurements representative of conditions in the first cell and in one or more neighbor cells of the first cell at a corresponding plurality of time instances;
determine a plurality of reward values based on differences between reward metric values at successive time instances;
associate each of the reward values with a corresponding previous action that changed the one or more operational parameters; and
select the previous action associated with a highest reward value as an action to change the one or more operational parameters for the first cell.

18. (canceled)

19. A reinforcement learning, RL, agent configured to adjust one or more operational parameters for a first cell of a communication network, wherein the RL agent is further configured to:
determine a plurality of reward metric values based on measurements representative of conditions in the first cell and in one or more neighbor cells of the first cell at a corresponding plurality of time instances;
determine a plurality of reward values based on differences between reward metric values at successive time instances;
associate each of the reward values with a corresponding previous action that changed the one or more operational parameters; and
select the previous action associated with a highest reward value as an action to change the one or more operational parameters for the first cell.

20-21. (canceled)

22. A non-transitory, computer-readable medium storing computer-executable instructions that, when executed by processing circuitry associated with a reinforcement learning, RL, agent configured to adjust one or more operational parameters for a first cell of a communication network, configure the RL agent to perform the method of claim 1.

23-25. (canceled)
